(19) United States
(12) Patent Application Publication
(10) Pub. No.: US 2004/0036238 A1
(43) Pub. Date: Feb. 26, 2004

(54) Steerable inflatable sled

(76) Inventor: Thomas M. Plante, Woodbury, MN (US)

Correspondence Address: Allison Johnson, Allison Johnson, P.A., 6016 Logan Ave. S., Minneapolis, MN, 55419, US

(21) Appl. No.: 10/227,984

(22) Filed: Aug. 26, 2002

(51) Int. Cl. B62B 9/04

(52) U.S. Cl. 280/18

(57) ABSTRACT

A steerable inflatable sled that includes a first inflatable segment, a second inflatable segment, and a predetermined articulation zone extending from the first inflatable segment to the second inflatable segment, the longitudinal axis of the sled extending through the first inflatable segment, said second inflatable segment and the articulation zone, when the sled is in motion on a surface, applying a force to the first inflatable segment sufficient to cause a bend at the predetermined articulation zone, changes the direction of travel of the sled.

### BACKGROUND

The invention relates to a steerable, inflatable sled.

Sledding down a hill covered with snow at high speeds can be enjoyable until an obstacle appears in the path of travel and the rider has no ability to change the direction in which the sled is traveling. Many sleds have no mechanism for steering other than shifting the weight of the rider as the sled travels across the snow. Sleds such as long wooden toboggans, round metal discs, and plastic sheets tend to be made from rigid materials that are difficult to control. Sleds that have a physical steering mechanism are often heavy and rigid and include rigid metal runners that are difficult for the rider to manipulate. The rigid metal runners and steering mechanisms also tend to slow down the sled, at times to a point of standstill.

Round inner tubes are often used for “tubing” down snow-covered hills. Round tubes have a natural tendency to travel along the “fall line” of the hill, changing direction of travel as the fall line, or contour, of the hill changes. Thus, the rider has little control over the direction of travel taken by the tube. This can be dangerous in light of the many hazards that may exist on a hill including trees, bumps, bushes, and other people sledding, tubing or sitting stationary on the hill.

### SUMMARY

In one aspect, the invention features a steerable inflatable sled that includes a first inflatable segment, a second inflatable segment, and a predetermined articulation zone extending from the first inflatable segment to the second inflatable segment, the longitudinal axis of the sled extending through the first inflatable segment, the second inflatable segment and the articulation zone, when the sled is in motion on a surface, applying a force to the first inflatable segment sufficient to cause a bend at the predetermined articulation zone, changes the direction of travel of the sled.

In one embodiment, the cross sectional dimension of the articulation zone taken in a plane perpendicular to the longitudinal axis of the sled is less than the cross sectional dimension of the first inflatable segment taken in a plane perpendicular to the longitudinal axis of the sled near the first end of the first inflatable segment and less than the cross sectional dimension of the second inflatable segment taken in a plane perpendicular to the longitudinal axis of the sled near the first end of the second inflatable segment.

In other embodiments, the bend experienced at the articulation zone when the force is applied to the first inflatable segment is in a direction substantially perpendicular to the longitudinal axis of the sled.

In another embodiment, the sled further includes at least one runner attached to a first surface of the sled. In some embodiments, the runner is flexible. In one embodiment, the sled further includes a plurality of runners attached to a surface of the first inflatable segment. In other embodiments, further includes a plurality of runners attached to the sled, at least one of the runners extending from the first inflatable segment through at least a portion of the articulation zone. In some embodiments, the sled further includes a plurality of runners attached to the sled, at least one of the runners extending from the first inflatable segment through the articulation zone to the second inflatable segment.

In another embodiment, the sled further includes a plurality of runners attached to a surface of the second inflatable segment. In other embodiments, the sled further includes a runner attached to a surface of the sled and extending from the first inflatable segment to the second inflatable segment. In some embodiments, at least one runner flexes when a force is applied to the first inflatable segment sufficient to cause a bend at the predetermined articulation zone. In another embodiment, at least one runner is plastic.

In some embodiments, at least one of the first inflatable segment and the second inflatable segment includes a plurality of air chambers. In other embodiments, the first inflatable segment includes at least one air chamber and the second inflatable segment includes at least one air chamber, at least one air chamber of the first inflatable segment being in fluid communication with at least one air chamber of the second inflatable segment.

In another embodiment, wherein the first inflatable segment includes an air chamber and the second inflatable segment includes an air chamber, wherein the air chamber of the first inflatable segment is not in fluid communication with the air chamber of the second inflatable segment.

In one embodiment, the first inflatable segment is in fluid communication with the second inflatable segment through the articulation zone. In some embodiments, the articulation zone includes an air chamber. In other embodiments, the articulation zone includes a living hinge.

In another aspect, the invention features a steerable sled including a first inflatable segment, a second inflatable segment; a predetermined articulation zone disposed between the first inflatable segment and the second inflatable segment, and a runner attached to at least a portion of the articulation zone. In one embodiment, the runner extends from the articulation zone to the first inflatable segment. In other embodiments, the runner extends from the first inflatable segment, through the articulation zone, to the second inflatable segment.

The invention features an inflatable sled that is capable of being easily steered, slowed and, if desired, stopped by the user. The sled can be controlled so as to travel along a desired path including against the fall line of a hill. The sled can be steered by the rider with a low level of force relative to sleds made from heavy rigid materials with stiff relatively inflexible runners such as metal runners.

The invention features an inflatable steerable sled that can be constructed for use on snow, water, ice or a combination thereof. In preferred constructions the sled is lightweight such that it can be easily transported by an individual in the inflated state.

Other features and advantages will become apparent from the following description of the preferred embodiment and the claims.

### BRIEF DESCRIPTION OF THE DRAWINGS

FIG. 1 is a top view of an inflatable steerable sled.

FIG. 2 is the bottom view of the sled of FIG. 1.

FIG. 3 is a side view of a runner of the sled of FIG. 1.

FIG. 4 is a side view of the sled of FIG. 1.

FIG. 5 is a bottom view of a sled according to a second embodiment.

FIG. 6 is a bottom view of a sled according to a third embodiment.

FIG. 7 is a top view of a sled according to a fourth embodiment.

FIG. 8 is a cross sectional view taken along line A-A of the sled of FIG. 7.

For ease of reference, like elements are given the same reference numerals throughout the drawings.

### DETAILED DESCRIPTION

For ease of description, the inflatable sled will be described with reference to its use on a snow covered hill, although it is contemplated that the sled can be used on a variety of surfaces including, e.g., water and ice.

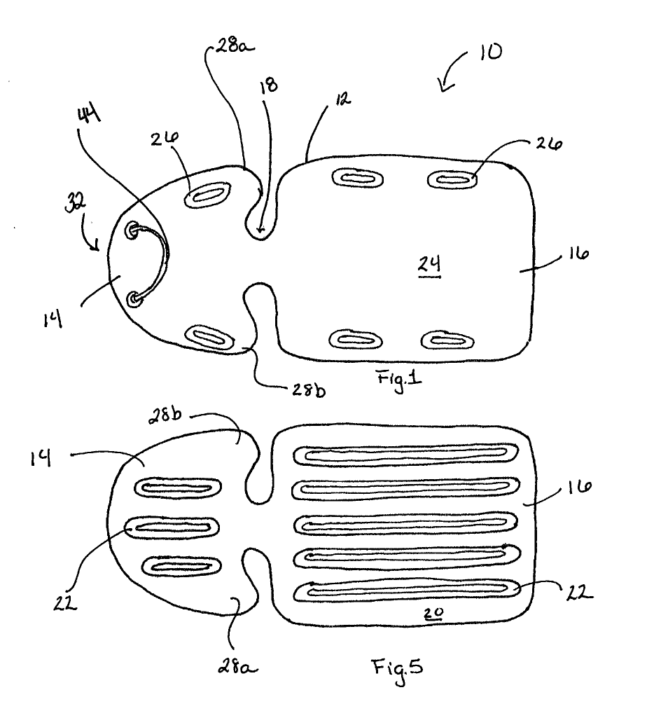

The sled 10 includes an inflatable body 12 that includes a first segment 14 that forms the forward most (e.g., down hill) portion of the sled, a second segment 16 forming the rearward most (e.g., uphill) portion of the sled 10, and an articulation zone 18 disposed between the first segment 14 and the second segment 16, as illustrated in FIGS. 1-4. The first segment 14 is contoured to include protuberances 28. The bottom (e.g., snow contacting) surface 20 of the sled 10 includes runners 22 and the top (e.g., rider contacting) surface 24 of the sled 10 includes handles 26.

The sled 10 is capable of being steered by a rider positioned in a sitting or prone position on the sled 10. The rider exerts a force against the first segment 14 of the sled 10 in the region of one of the protuberances 28a, 28b of the first segment 14. Pushing against the sled in the area of the protuberance 28, and optionally the handle 26, where present, causes a bend at the articulation zone 18 in a region of the articulation zone 18 opposite the side of the sled against which the force was exerted. The force is preferably exerted in a downward (i.e., toward the surface on which the sled is riding) and outward (i.e., away from the rider) direction. When in the prone position, for example, the rider can exert a force using his or her hands or forearms in the region of one of the protuberances. The force causes the articulation zone to bend, and, where present, the runners 22 to flex, which causes a change in the direction of travel of the sled causing the sled 10 to turn. Pushing downward on the first segment 14 toward the surface (e.g., snow) on which the sled is riding increases the contact between the sled and the riding surface and allows the sled to turn more sharply. Alternatively, the rider can simultaneously push on the sled in the area of one protuberance (e.g., 28a) and pull on the sled in the area of the other protuberance (e.g., 28b) to effect a change in direction of travel of the sled. The protuberances 28a, 28b are preferably dimensioned to limit the extent of deflection of the first segment, which prevents “over steering” of the sled.

The sled is constructed from a polymeric material including, e.g., polyvinylchloride, polyurethane, thermoplastic elastomer, natural and synthetic rubbers, and combinations thereof. The polymer can be reinforced with various components including, e.g., woven webs, nonwoven webs, fibers, filaments, and combinations thereof.

The first segment 14 includes an arcuate portion, which preferably provides aerodynamic properties to the sled and low resistance to movement in deep snow. Alternatively the first segment could have a linear or squared-off end. The first segment 14 is contoured to include regions, i.e., protuberances 28. Preferably the protuberances are dimensioned to provide an area on which a rider in the prone position with elbows bent can rest his or her elbows and forearms. Alternatively, a rider in a sitting position can rest his or her feet against regions 28. The first segment 14 can be of a variety of shapes including, e.g., spade, triangle, and semicircle, and preferably is of a shape that enhances the aerodynamic properties of the sled. Preferably the sled has an arcuate end 32 at its leading end.

The second segment 16 provides a platform on which a person can sit or lie (e.g., in a prone position facing down into the sled or in a position facing up and away from the surface of the sled). The second segment 16 is preferably generally rectangular but can be of a variety of shapes including, e.g., square, triangular, rhomboid, circular, elliptical, and hourglass.

The predetermined articulation zone 18 is disposed between the first segment 14 and the second segment 16. The articulation zone 18 can be inflatable and in fluid communication with the first segment 14 and the second segment 16. Alternatively, the articulation zone can be a living hinge formed, e.g., by a sheet extending between the first inflatable segment and the second inflatable segment or by two plies bonded together. The articulation zone “necks in” relative to the first segment 14 and second segment 16. That is, the articulation zone 18 has a smaller cross sectional dimension taken in a plane perpendicular to the longitudinal axis of the sled relative to both the cross sectional dimension of the region of the first segment near the articulation zone, and the cross sectional dimension of the second segment near the articulation zone. The articulation zone 18 provides a pivot about which the first segment 14 rotates when a force is exerted by the rider against at least one of the protuberances 28.

The first segment 14, the second segment 16 and the articulation zone 18 of the inflatable body form a single air chamber 36 such that the segments 14, 16, 18 are in fluid communication with each other. The air chamber 36 includes a number of gusset walls 46 positioned to create structure within the air chamber and to impart rigidity to the inflatable body of the sled. The gusset walls 46 extend from the top wall 48 of the chamber to an opposite bottom wall 50 of the chamber. A gusset wall 46 in the air chamber can be formed by bonding a gusset wall to a top sheet and a bottom sheet. Alternatively, the chamber can include regions defined at least in part by a divider formed by bonding two portions (e.g., the top and bottom wall) of the outer wall of the inflatable body together. The gusset walls 46 extend along a portion of the longitudinal extent of the inflatable body to create multiple open cells in a single air chamber body. The gusset walls can extend either continuously or discontinuously along an extent of the air chamber. Alternatively, the gusset walls or dividers can be positioned along an entire extent of the chamber to create multiple closed cells, i.e., multiple separate air chambers. In one embodiment, the gusset walls or dividers extend along the entire length of the longitudinal extent to create multiple closed cells in the inflatable body.

In other embodiments, the first segment 14, the second segment 16 and the articulation zone 18 are at least two separate chambers such that the chamber(s) of the first segment and the chamber(s) of the second segment are not in fluid communication with each other. The separate chambers can have their own inflation/deflation port. The articulation zone, where inflatable, can be in fluid communication with the first segment, the second segments, or a combination thereof, or it can include a separate chamber.

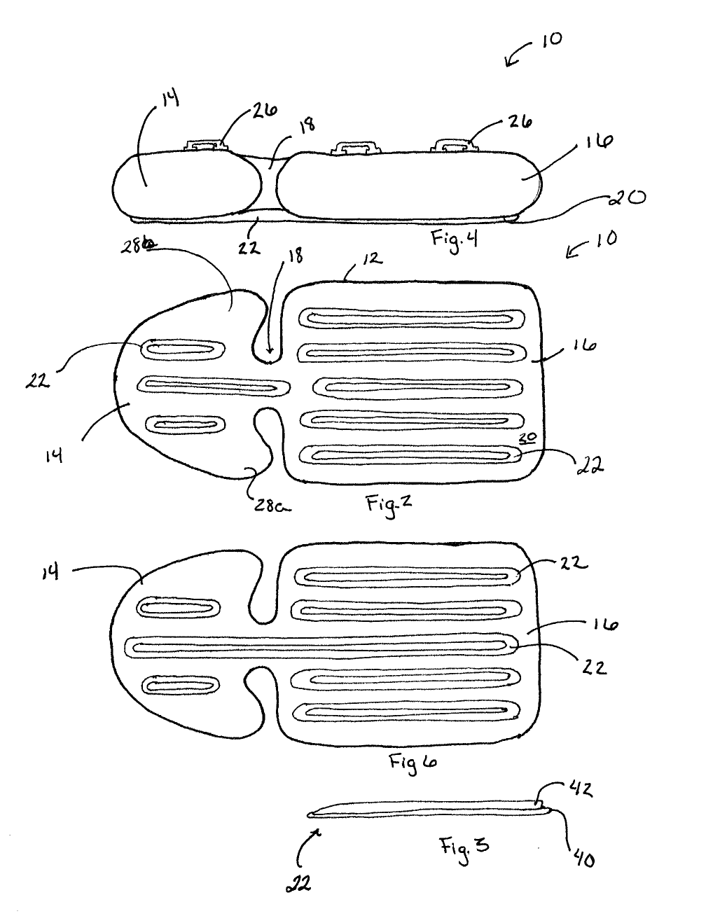

Runners 22 are attached to the snow-contacting surface 20 of the sled 10 as illustrated in FIGS. 2-6. The runners 22 can be attached to at least a portion of the first segment 14, the second segment 16, the articulation zone 18 or any combination thereof. The runners 22 are elongated strips that are attached to the exterior surface of the sled to assist the movement of the sled over a surface. FIG. 3 illustrates a runner 22 that includes a base 40 and a protrusion 42 extending away from the base 40. The base 40 is attached to the surface of the sled 10 such that the protrusion 42 extends away from the surface of the sled. The runners 22 can be attached to the surface of the sled in a variety of configurations. Referring to FIG. 2, the sled 10 includes a number of runners 22 attached to the first inflatable segment 14, a number of runners attached to the second inflatable segment 16, and a runner 22b extending from the first segment 14 through the articulation zone 18 to the second inflatable segment 16.

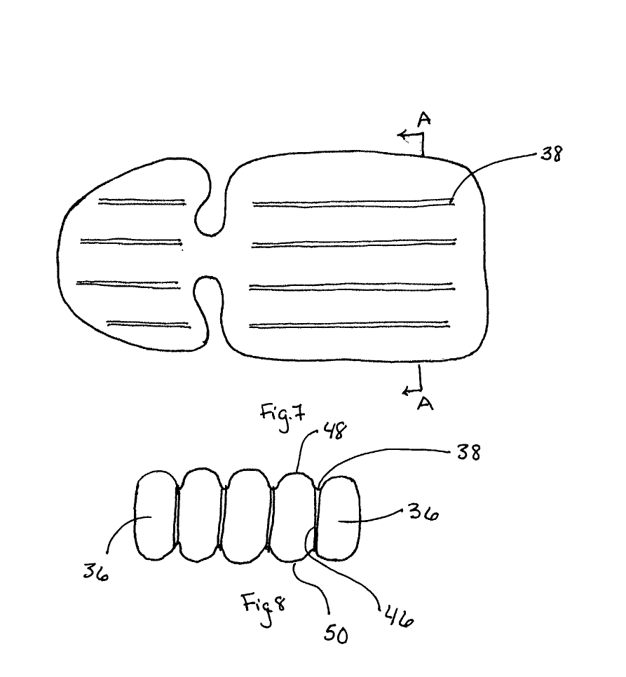

In another embodiment, a number of runners 22 are attached to the first and second segments, and one runner extends along the bottom surface 20 of the sled 10 from the first segment 14, through the articulation zone 18 and along a major portion of the length of the second segment 16, as illustrated in FIG. 6.

In another embodiment, a number of runners 22 are attached to both the first inflatable segment 14 and the second segment 16, as illustrated in FIG. 5.

The runners 22 can be attached to the sled with any suitable attachment mechanism including, e.g., adhesive composition, high frequency welding, heat welding, stitching, mechanical fasteners and combinations thereof.

The runners 22 can be made from a variety of materials including, e.g., plastic (e.g., flexible plastic), foam, metal and combinations thereof.

The handles 24 and 26 of the sled are positioned on the sled to provide suitable grips for at least one rider. FIGS. 1 and 4, illustrates handle positioned near the protuberances 32 of the first segment 14. The handles provide something on to which the rider can hold and can also provide a structure against which a rider can exert a force to assist in turning the sled.

The sled can also include a handle 44 positioned near the terminal end of the first inflatable segment of the sled, as illustrated in FIG. 1. The handle 44 is preferably flexible is useful for a variety of functions including providing a device to grasp for pulling the sled (e.g., up a hill), balance to the rider, and steering assistance. When the sled 10 is in motion, the rider can pull on the handle 44 to assist the turning effort. In one embodiment, the rider hangs on to the handle 44 while exerting pressure on the protuberance region of the first segment 14. The handle 44 can be made from a variety of materials including, e.g., rope, twine, plastic, webbing, and combinations thereof

The handles can be attached to the sled with any suitable attachment mechanism including, e.g., adhesive composition, sonic welding, heat welding, stitching, mechanical fasteners and combinations thereof. The handles can be made from a variety of materials including, e.g., plastic (e.g., flexible plastic), rope, metal, and combinations thereof.

Other embodiments are within the claims. One or more handles, for example, can be replaced with a ridge. When constructed for use on water, for example, the sled can include fins. Preferably the fins are positioned and dimensioned to provide steering control. The fins can extend from the runners and can exist in place of or in addition to the runners. The fins can extend away from the water-contacting surface of the sled such that they would be directed into the water. In one embodiment, the fins are attached to the first inflatable segment, the second inflatable segment, the articulation zone or a combination thereof. In one embodiment, fins are placed near the protuberances on the water-contacting surface of the sled.

In another aspect, the sled is constructed (e.g., through molding, e.g., injection molding) from a flexible, cellular material. The cellular material is sufficiently rigid to support the weight of a rider and sufficiently flexible to permit flexure through the articulation zone. The runners, handles or a combination thereof, can be molded as an integral component of the body of the sled.

What is claimed is:

1. A steerable inflatable sled comprising:
a first inflatable segment;
a second inflatable segment; and
a predetermined articulation zone extending from said first inflatable segment to said second inflatable segment,
the longitudinal axis of the sled extending through said first inflatable segment, said second inflatable segment and said articulation zone,
when the sled is in motion on a surface, applying a force to said first inflatable segment sufficient to cause a bend at said predetermined articulation zone, changes the direction of travel of the sled.

2. The sled of claim 1, wherein the cross sectional dimension of said articulation zone taken in a plane perpendicular to the longitudinal axis of the sled is less than the cross sectional dimension of said first inflatable segment taken in a plane perpendicular to the longitudinal axis of the sled near said first end of said first inflatable segment, and less than the cross sectional dimension of said second inflatable segment taken in a plane perpendicular to the longitudinal axis of the sled near said first end of said second inflatable segment.

3. The sled of claim 1, wherein the bend experienced at said articulation zone when said force is applied to said first inflatable segment is in a direction substantially perpendicular to the longitudinal axis of the sled.

4. The sled of claim 1, further comprising at least one runner attached to a first surface of said sled.

5. The sled of claim 4, wherein said runner is flexible.

6. The sled of claim 1, further comprising a plurality of runners attached to a surface of said first inflatable segment.

7. The sled of claim 1, further comprising a plurality of runners attached to said sled, at least one of said runners extending from said first inflatable segment through at least a portion of said articulation zone.

8. The sled of claim 1, further comprising a plurality of runners attached to said sled, at least one of said runners extending from said first inflatable segment through said articulation zone to said second inflatable segment.

9. The sled of claim 1, further comprising a plurality of runners attached to a surface of said second inflatable segment.

10. The sled of claim 6, further comprising a plurality of runners attached to a surface of said second inflatable segment.

11. The sled of claim 1, further comprising a runner attached to a surface of said sled and extending from said first inflatable segment to said second inflatable segment.

12. The sled of claim 4, wherein said at least one runner flexes when a force is applied to said first inflatable segment sufficient to cause a bend at said predetermined articulation zone.

13. The sled of claim 4, wherein said at least one runner is plastic.

14. The sled of claim 1, wherein at least one of said first inflatable segment and said second inflatable segment comprises a plurality of air chambers.

15. The sled of claim 1, wherein the first inflatable segment comprises at least one air chamber and said second inflatable segment comprises at least one air chamber, an air chamber of said first inflatable segment being in fluid communication with an air chamber of said second inflatable segment.

16. The sled of claim 1, wherein the first inflatable segment comprises an air chamber and said second inflatable segment comprises an air chamber, wherein said air chamber of said first inflatable segment is not in fluid communication with said air chamber of said second inflatable segment.

17. The sled of claim 1, wherein said first inflatable segment is in fluid communication with said second inflatable segment through said articulation zone.

18. The sled of claim 1, wherein said articulation zone comprises an air chamber.

19. The sled of claim 1, wherein said articulation zone comprises a living hinge.

20. A steerable sled comprising:
a first inflatable segment;
a second inflatable segment;
a predetermined articulation zone disposed between said first inflatable segment and said second inflatable segment; and
a runner attached to at least a portion of said articulation zone.

21. The steerable sled of claim 20, wherein said runner extends from said articulation zone to said first inflatable segment.

22. The steerable sled of claim 20, wherein said runner extends from said first inflatable segment, through said articulation zone, to said second inflatable segment.

23. A steerable sled comprising:
a first segment;
a second segment;
a predetermined articulation zone disposed between said first inflatable segment and said second inflatable segment; and
a runner attached to at least a portion of said articulation zone.
